(19) United States
(12) Patent Application Publication
(10) Pub. No.: US 2019/0215521 A1
(43) Pub. Date: Jul. 11, 2019

(54) METHOD AND APPARATUS FOR VIDEO CODING USING DECODER SIDE INTRA PREDICTION DERIVATION

(71) Applicant: MEDIATEK INC., Hsin-chu (TW)

(72) Inventors: Tzu-Der CHUANG, Zhubei City, Hsinchu County (TW); Ching-Yeh CHEN, Taipei City (TW); Zhi-Yi LIN, Hsinchu City (TW); Jing YE, San Jose, CA (US); Shan LIU, San Jose, CA (US)

(21) Appl. No.: 16/335,435

(22) PCT Filed: Sep. 18, 2017
(86) PCT No.: PCT/CN2017/102043

§ 371 Date: Mar. 21, 2019

Related U.S. Application Data
(60) Provisional application No. 62/398,564, filed on Sep. 23, 2016.
(60) Provisional application No. 62/397,953, filed on Sep. 22, 2016.

(51) Int. Cl. H04N 19/159; H04N 19/176; H04N 19/55; H04N 19/105; H04N 19/139

(52) U.S. Cl. CPC H04N 19/159; H04N 19/176; H04N 19/139; H04N 19/105; H04N 19/55

(57) ABSTRACT

Methods and apparatus using decoder-side Intra mode derivation (DIMD) are disclosed. According to one method, two-mode DIMD is used, where two DIMD modes are developed. The DIMD predictors for the two DIMD modes are derived. A final DIMD predictor is derived by blending the two DIMD predictors. In a second method, the DIMD mode is combined with a normal Intra mode to derive a combined DIMND-Intra predictor. In a third method, the DIMD mode is combined with an Inter mode to derive a combined DIMD-Inter predictor. Various blending methods to combine the DIMD mode and another mode are also disclosed.

### CROSS REFERENCE TO RELATED APPLICATIONS

The present invention claims priority to U.S. Provisional Patent Application Ser. No. 62/397,953, filed on Sep. 22, 2016 and U.S. Provisional Patent Application Ser. No. 62/398,564, filed on Sep. 23, 2016. The U.S. Provisional patent applications are hereby incorporated by reference in their entireties.

### TECHNICAL FIELD

The present invention relates to decoder side Intra prediction derivation in video coding. In particular, the present invention discloses template based Intra prediction in combination with another template based Intra prediction, a normal Intra prediction or Inter prediction.

### BACKGROUND

The High Efficiency Video Coding (HEVC) standard is developed under the joint video project of the ITU-T Video Coding Experts Group (VCEG) and the ISO/IEC Moving Picture Experts Group (MPEG) standardization organizations, and is especially with partnership known as the Joint Collaborative Team on Video Coding (JCT-VC). In HEVC, one slice is partitioned into multiple coding tree units (CTU). In main profile, the minimum and the maximum sizes of CTU are specified by the syntax elements in the sequence parameter set (SPS). The allowed CTU size can be 8×8, 16×16, 32×32, or 64×64. For each slice, the CTUs within the slice are processed according to a raster scan order.

The CTU is further partitioned into multiple coding units (CU) to adapt to various local characteristics. A quadtree, denoted as the coding tree, is used to partition the CTU into multiple CUs. Let CTU size be M×M, where M is one of the values of 64, 32, or 16. The CTU can be a single CU (i.e., no splitting) or can be split into four smaller units of equal sizes (i.e., M/2×M/2 each), which correspond to the nodes of the coding tree. If units are leaf nodes of the coding tree, the units become CUs. Otherwise, the quadtree splitting process can be iterated until the size for a node reaches a minimum allowed CU size as specified in the SPS (Sequence Parameter Set). This representation results in a recursive structure as specified by a coding tree (also referred to as a partition tree structure).

Furthermore, according to HEVC, each CU can be partitioned into one or more prediction units (PU). Coupled with the CU, the PU works as a basic representative block for sharing the prediction information. Inside each PU, the same prediction process is applied and the relevant information is transmitted to the decoder on a PU basis. A CU can be split into one, two or four PUs according to the PU splitting type. Unlike the CU, the PU may only be split once according to HEVC. The partitions shown in the second row correspond to asymmetric partitions, where the two partitioned parts have different sizes.

After obtaining the residual block by the prediction process based on PU splitting type, the prediction residues of a CU can be partitioned into transform units (TU) according to another quadtree structure which is analogous to the coding tree for the CU. The TU is a basic representative block having residual or transform coefficients for applying the integer transform and quantization. For each TU, one integer transform having the same size to the TU is applied to obtain residual coefficients. These coefficients are transmitted to the decoder after quantization on a TU basis.

The terms coding tree block (CTB), coding block (CB), prediction block (PB), and transform block (TB) are defined to specify the 2-D sample array of one colour component associated with CTU, CU, PU, and TU, respectively. Thus, a CTU consists of one luma CTB, two chroma CTBs, and associated syntax elements. A similar relationship is valid for CU, PU, and TU. The tree partitioning is generally applied simultaneously to both luma and chroma, although exceptions apply when certain minimum sizes are reached for chroma.

A new block partition method, named as quadtree plus binary tree (QTBT) structure, has been disclosed for the next generation video coding (J. An, et al., “Block partitioning structure for next generation video coding,” MPEG Doc. m37524 and ITU-T SG16 Doc. COM16-C966, October 2015). According to the QTBT structure, a coding tree block (CTB) is firstly partitioned by a quadtree structure. The quadtree leaf nodes are further partitioned by a binary tree structure. The binary tree leaf nodes, namely coding blocks (CBs), are used for prediction and transform without any further partitioning. For P and B slices the luma and chroma CTBs in one coding tree unit (CTU) share the same QTBT structure. For I slice the luma CTB is partitioned into CBs by a QTBT structure, and two chroma CTBs are partitioned into chroma CBs by another QTBT structure.

A CTU (or CTB for I slice), which is the root node of a quadtree, is firstly partitioned by a quadtree, where the quadtree splitting of one node can be iterated until the node reaches the minimum allowed quadtree leaf node size (MinQTSize). If the quadtree leaf node size is not larger than the maximum allowed binary tree root node size (MaxBTSize), it can be further partitioned by a binary tree. The binary tree splitting of one node can be iterated until the node reaches the minimum allowed binary tree leaf node size (MinBTSize) or the maximum allowed binary tree depth (MaxBTDepth). The binary tree leaf node, namely CU (or CB for I slice), will be used for prediction (e.g. intra-picture or inter-picture prediction) and transform without any further partitioning. There are two splitting types in the binary tree splitting: symmetric horizontal splitting and symmetric vertical splitting.

FIG. 1 illustrates an example of block partitioning 110 and its corresponding QTBT 120. The solid lines indicate quadtree splitting and dotted lines indicate binary tree splitting. In each splitting node (i.e., non-leaf node) of the binary tree, one flag indicates which splitting type (horizontal or vertical) is used, 0 may indicate horizontal splitting and 1 may indicate vertical splitting.

An international standard organization called JVET (joint video exploration team) has been established by both ITU-T VCEG and ISO/IEC MPEG to study the next generation video coding technologies. Reference software called JEM (joint exploration model) is built up based on HEVC's reference software (HM). Some new video coding methods, including QTBT and 65 Intra prediction directions, are included in JEM software.

A decoder side Intra prediction mode derivation (DIMD) has also been considered for the next generation video coding. In JVET-C0061 (X. Xiu, et al., “Decoder-side intra mode derivation”, JVET of ITU-T SG 16 WP 3 and ISO/IEC JTC 1/SC 29/WG 11, 32rd Meeting: Place, Date 2016, Document: JVET-C0061, May, 2016), the DIMD is disclosed, where the neighbouring reconstructed samples of the current block are used as a template. Reconstructed pixels in the template are used and compared with the predicted pixels in the same positions. The predicted pixels are generated using the reference pixels corresponding to the neighbouring reconstructed pixels around the template. For each of the possible Intra prediction modes, the encoder and decoder generate predicted pixels in the similar way as the Intra prediction in HEVC for the positions in the template. The distortion between the predicted pixels and the reconstructed pixels in the template are compared and recorded. The Intra prediction mode with the minimum distortion is selected as the derived Intra prediction mode. During the template matching search, the number of available Intra prediction modes is increased to 129 (from 67) and the interpolation filter precision for reference sample is increased to 1/64-pel (from 1/32-pel). An illustration of such prediction is shown in FIG. 2, where L is the width and height of the template for both the pixels on top of current block and to the left of current block. When block size is 2N×2N, the best Intra prediction mode from template matching search is used as the final Intra prediction mode. When block size is N×N, the best Intra prediction mode from template matching search is put in the MPM set as the first candidate. The repeated mode in the MPM is removed.

### SUMMARY

Methods and apparatus using decoder-side Intra mode derivation (DIMD) are disclosed. According to one method, a first DIMD mode for a current block is derived based on a left template of the current block, an above template of the current block or both. Also, a second DIMD mode for the current block is derived based on the left template of the current block, the above template of the current block or both. Intra mode processing is then applied to the current block according to a target Intra mode selected from an Intra mode set including two-mode DIMD corresponding to the first DIMD mode and the second DIMD mode.

In one embodiment of the first method, the first DIMD mode is derived only based on the left template of the current block and the second DIMD mode is derived only based on the above template of the current block. When the two-mode DIMD is used, the Intra mode processing comprises generating a two-mode DIMD predictor by blending a first DIMD predictor corresponding to the first DIMD mode and a second DIMD predictor corresponding to the second DIMD mode. For example, the two-mode DIMD predictor can be generated using uniform blending by combining the first DIMD predictor and the second DIMD predictor according to a weighted sum, where weighting factors are uniform for an entire current block. In another example, the two-mode DIMD predictor is generated using position-dependent blending by combining the first DIMD predictor and the second DIMD predictor according to a weighted sum, where weighting factors are position dependent. The current block can be divided along top-left to bottom-right diagonal direction into an upper-right region and a lower-left region; a first predictor for pixels in the upper-right region is determined according to (n*first DIMD predictor+m*second DIMD predictor+rounding_offset)/(m+n); a second predictor for pixels in the lower-left region is determined according to (m*first DIMD predictor+n*second DIMD predictor+rounding_offset)/(m+n); and where rounding_offset is an offset value for a rounding operation and m and n are two weighting factors. The two-mode DIMD predictor can also be generated using bilinear weighting based on four corner values of the current block with the first DIMD predictor at a bottom-left corner, the second DIMD predictor at a top-right corner, an average of the first DIMD predictor and the second DIMD predictor at a top-left corner and a bottom-right corner.

In yet another embodiment, when the two-mode DIMD is used, the Intra mode processing comprises deriving most probable mode (MPM), applying coefficient scan, applying Non-Separable Secondary Transform (NSST), applying Enhanced Multiple Transforms (EMT) to the current block based on a best mode selected from the first DIMD mode and the second DIMD mode, or a combination thereof.

According to a second method, a normal Intra mode is determined from a set of Intra modes. A target DIMD mode for a current block is derived based on a left template of the current block, an above template of the current block or both. A combined Intra predictor is generated by blending a DIMD predictor corresponding to the target DIMD mode and a normal Intra predictor corresponding to the normal Intra mode. Intra mode processing is applied to the current block using the combined Intra predictor.

In one embodiment of the second method, deriving the target DIMD mode for the current block comprises deriving a regular DIMD mode based on both the left template of the current block and the above template of the current block and using the regular DIMD mode as the target DIMD mode if the regular DIMD mode is different from the normal Intra mode. If the regular DIMD mode is equal to the normal Intra mode, another DIMD mode corresponding to a first DIMD mode derived based on the left template of the current block only, a second DIMD mode derived based on the above template of the current block only, or a best one between the first DIMD mode and the second DIMD mode is selected as the target DIMD mode. If the first DIMD mode and the second DIMD mode are equal to the normal Intra mode, a predefined Intra mode, such as DC or planar mode, is selected as the target DIMD mode.

In one embodiment of the second method, if the normal Intra mode is one non-angular mode, a best DIMD angular mode is derived from a set of angular modes and the best DIMD angular mode is used as the target DIMD mode. If the normal Intra mode is one angular mode, a best DIMD mode is derived for the current block. If the best DIMD mode is an angular mode, a result regarding whether angular difference between the normal Intra mode and the best DIMD angular mode is smaller than a threshold is checked; if the result is true, a best DIMD non-angular mode is derived as the target DIMD mode; and if the result is false, the best DIMD angular mode is used as the target DIMD mode.

The combined Intra predictor can be generated by blending the DIMD predictor and the normal Intra predictor according to uniform blending or position dependent blending. For the position dependent blending, the current block can be partitioned along bottom-left to top-right diagonal direction into an upper-left region and a lower-right region and different weighting factors are used for these two regions. In another example, the current block is divided into multiple row/column bands and weighting factors are dependent on a target row/column band that a pixel is located. In yet another example, the combined Intra predictor is generated using bilinear weighting based on four corner values of the current block with the DIMD predictor at a top-left corner, the normal Intra predictor at a bottom-right corner, an average of the DIMD predictor and the normal Intra predictor at a top-right corner and a bottom-left corner.

According to a third method, if an Inter-DIMD mode is used for a current block of the current image: a DIMD-derived Intra mode for the current block in the current image is derived based on a left template of the current block and an above template of the current block; a DIMD predictor for the current block corresponding to the DIMD-derived Intra mode is derived; an Inter predictor corresponding to an Inter mode for the current block is derived; a combined Inter-DIMD predictor is generated by blending the DIMD predictor and the Inter predictor; and the current block is encoded or decoded using the combined Inter-DIMD predictor for Inter prediction or including the combined Inter-DIMD predictor in a candidate list for the current block.

The combined Inter-DIMD predictor can be generated by blending the DIMD predictor and the Inter predictor according to uniform blending or position dependent blending. For the position dependent blending, the current block can be partitioned along bottom-left to top-right diagonal direction into an upper-left region and a lower-right region and different weighting factors are used for these two regions. In another example, the current block is divided into multiple row/column bands and weighting factors are dependent on a target row/column band that a pixel is located. In yet another example, the combined Inter-DIMD predictor is generated using bilinear weighting based on four corner values of the current block with the DIMD predictor at a top-left corner, the Inter predictor at a bottom-right corner, an average of the DIMD predictor and the normal Intra predictor at a top-right corner and a bottom-left corner.

When the combined Inter-DIMD predictor is generated using uniform blending and the combined Inter-DIMD predictor is used for Inter prediction of the current block, a current pixel can be modified into a modified current pixel to include a part of the combined Inter-DIMD predictor corresponding to the DIMD predictor so that a residual between the current pixel and the combined Inter-DIMD predictor can be calculated from a difference between the modified current pixel and the Inter predictor.

In another embodiment, the weighting factors can be further dependent on the DIMD-derived Intra mode. For example, if the DIMD-derived Intra mode is an angular mode and close to horizontal Intra mode, the weighting factors can be further dependent on horizontal distance of a current pixel with respect to a vertical edge of the current block. If the DIMD-derived Intra mode is the angular mode and close to vertical Intra, the weighting factors can be further dependent on vertical distance of the current pixel with respect to a horizontal edge of the current block. In another example, the current block is partitioned into multiple bands in a target direction orthogonal to a direction of the DIMD-derived Intra mode and the weighting factors are further dependent on a target band that a current pixel is located.

In one embodiment, whether the Inter-DIMD mode is used for the current block of the current image can be indicated by a flag in the bitstream. In another embodiment, the combined Inter-DIMD predictor is generated using blending by linearly combining the DIMD predictor and the Inter predictor according to weighting factors, where the weighting factors are different for the current block coded in a Merge mode and an Advanced Motion Vector Prediction (AMVP) mode.

### BRIEF DESCRIPTION OF DRAWINGS

FIG. 1 illustrates an example of block partition using quadtree structure to partition a coding tree unit (CTU) into coding units (CUs).

FIG. 2 illustrates an example of decoder side Intra mode derivation (DIMD), where the template correspond to pixels on the top of current block and to the left of current block.

FIG. 3 illustrates the left and above templates used for the decoder-side Intra mode derivation, where a target block can be a current block.

FIG. 4 illustrates an example of position-dependent blending for two-mode DIMD, where a CU is divided along top-left to bottom-right diagonal direction into an upper-right region and a lower-left region and different weightings are used for these two regions.

FIG. 5 illustrates an example of position dependent blending for two-mode DIMD according to bilinear weighting, where the weighting factors of four corners are shown.

FIG. 6 illustrates an example of position dependent blending for combined DIMD and normal Intra mode, where a CU is divided along top-left to bottom-right diagonal direction into an upper-right region and a lower-left region and different weightings are used for these two regions.

FIG. 7 illustrates another example of position dependent blending for the combined DIMD and normal Intra mode, where a CU is divided into multiple row/column bands and weighting factors are dependent on a target row/column band where a pixel is located.

FIG. 8 illustrates an example of position dependent blending for the combined DIMD and normal Intra mod according to bilinear weighting, where the weighting factors of four corners are shown.

FIG. 9 illustrates an example of blending for the combined DIMD and normal Intra mod depending on the signalled normal Intra mode.

FIG. 10 illustrates an example of position dependent blending for combined DIMD and Inter mode, where a CU is divided along top-left to bottom-right diagonal direction into an upper-right region and a lower-left region and different weightings are used for these two regions.

FIG. 11 illustrates another example of position dependent blending for the combined DIMD and Inter mode, where a CU is divided into multiple row/column bands and weighting factors are dependent on a target row/column band where a pixel is located.

FIG. 12 illustrates an example of position dependent blending for the combined DIMD and Inter mod according to bilinear weighting, where the weighting factors of four corners are shown.

FIG. 13A illustrates an example of position dependent blending for the case that the derived mode is an angular mode and close to the vertical mode, where four different weighting coefficients are used depending on vertical distance of a target pixel in the block.

FIG. 13B illustrates an example of position dependent blending for the case that the derived mode is an angular mode and close to the horizontal mode, where four different weighting coefficients are used depending on horizontal distance of a target pixel in the block.

FIG. 14A illustrates an example of position dependent blending e, where the block is partitioned into uniform weighting bands in a direction orthogonal to the angular Intra prediction direction.

FIG. 14B illustrates an example of position dependent blending e, where the block is partitioned into non-uniform weighting bands in a direction orthogonal to the angular Intra prediction direction.

FIG. 15 illustrates a flowchart of an exemplary coding system using two-mode decoder-side Intra mode derivation (DIMD).

FIG. 16 illustrates a flowchart of an exemplary coding system using a combined decoder-side Intra mode derivation (DIMD) mode and a normal Intra mode.

FIG. 17 illustrates a flowchart of an exemplary coding system using a combined decoder-side Intra mode derivation (DIMD) mode and a normal Intra mode.

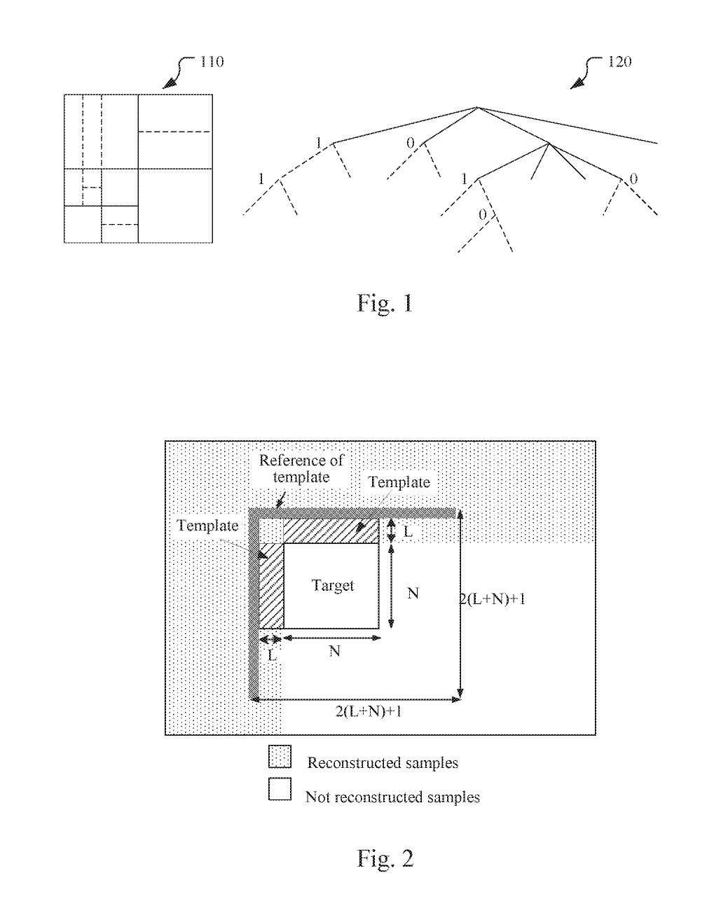

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

As mentioned before, the Decoder-side Intra mode derivation (DIMD) process disclosed in JVET-C0061 uses the derived Intra prediction mode as a final Intra prediction mode for a 2N×2N block and uses the derived Intra prediction mode as a first candidate of the MPM (most probable mode) set for an N×N block.

In the present invention, the DIMD is extended to include a second mode to form a combined mode so as to generated a combined predictor for the current block, where the second mode may be another DIMD mode, a normal Intra mode signalled from the encoder, or a Inter mode such as Merge mode or Advanced Motion Vector Prediction (AMVP) mode. Various joint DIMD Intra prediction techniques are disclosed as follows to improve coding performance of video coding systems.

Two-Mode DIMD:

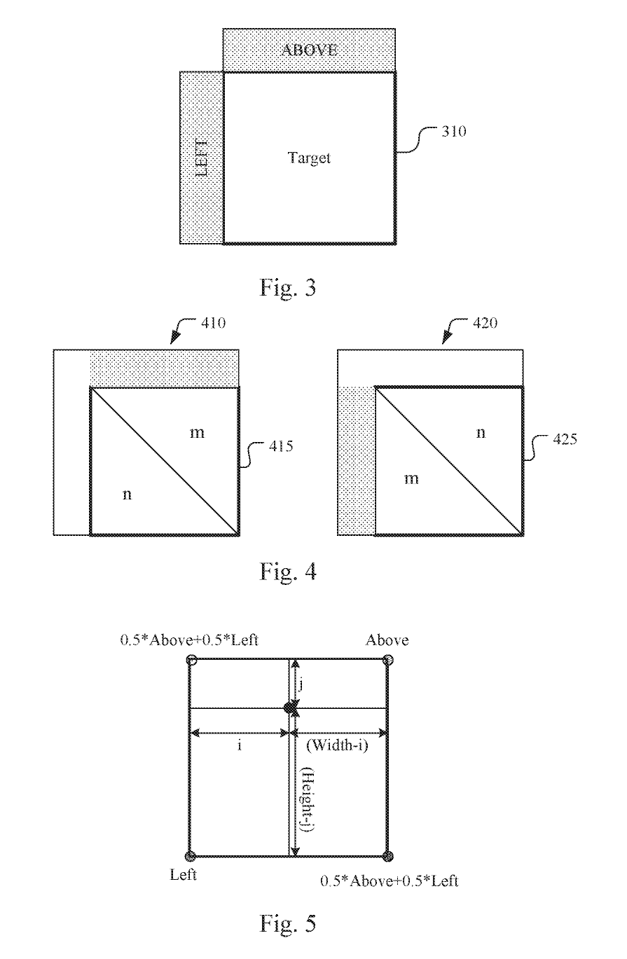

In JVET-C0061, the DIMD process only derives one best Intra mode by using both of the left and above templates. In this embodiment, the left template and above template are used to derive two different DIMD derived Intra modes. The left and above templates are shown in FIG. 3, where block 310 corresponds to a target block that can be a current block. According to one embodiment of the two-mode DIMD technique, one DIMD Intra mode is derived by using only the above template and another DIMD Intra mode is derived using only the left template. The DIMD Intra mode derived by using only the above template is referred as above-template-only DIMD and the DIMD Intra mode derived by using only the left template is referred as left-template-only DIMD for convenience. The two-mode DIMD will then derive a best mode from these two modes (i.e., above-template-only DIMD and left-template-only DIMD) by evaluating the performance based on above and left templates.

The best mode can be stored in the Intra mode buffer for various applications such as MPM (most probable mode) coding, coefficient scan, NSST, and EMT processes. The Intra prediction residues usually are transformed and quantized, and the quantized transform block is then converted from two-dimensional data into one-dimensional data through coefficient scan. In more advanced video coding, the scanning pattern may be dependent on the Intra mode selected for the block. The Non-Separable Secondary Transform (NSST) and Enhanced Multiple Transforms (EMT) processes are new coding tools being considered for the next generation video coding standard. In the next generation video coding, a video encoder is allowed to apply a forward primary transform to a residual block followed by a secondary transform. After the secondary transform is applied, the transformed block is quantized. The secondary transform can be a rotational transform (ROT). Also NSST can be used. Also, the EMT technique is proposed for both Intra and Inter prediction residual. In EMT, an EMT flag in the CU-level flag may be signalled to indicate whether only the conventional DCT-2 or other non-DCT2 type transforms are used. If the CU-level EMT flag is signalled as 1 (i.e., indicating non-DCT2 type transforms), an EMT index in the CU level or the TU level can be signalled to indicate the non-DCT2 type transform selected for the TUs.

In one embodiment, the DIMD mode derived by using the left template (i.e., left-template-only DIMD) is stored in the Intra mode buffer. In yet another embodiment, the DIMD mode derived by using the above template (i.e., above-template-only DIMD) is stored in the Intra mode buffer. In another embodiment, the derived two modes can be the Intra modes with the best and second best costs among the Intra prediction mode set by evaluating the cost function based on the left template and above template.

In another embodiment, the predictor of the current block are generated by a weighted sum of these two DIMD derived Intra predictors. Different blending methods can be used to derive the predictor as shown below.

Uniform Blending:

Predictor=(a*left_predictor+b*above_predictor+rounding_offset)/(a+b). (1)

where a and b can be {1, 1} or {3,1}.

In the above equation, Predictor is the final two-mode DIMD predictor for a given pixel in the block, left_predictor corresponds to the predictor derived from the left template for the given pixel in the block, above_predictor corresponds to the predictor derived from the above template for the given pixel in the block and rounding_offset is an offset value. In the above equation, the coordinates of the pixel location are omitted. Parameter (also referred to as weighting factors) a and b are constants independent of the pixel location. That is, the weighting factors for the uniform blending are uniform for an entire current block.

Position-Dependent Blending:

The weighting can be position dependent. For example, the current block may be divided into multiple regions. For different regions, the weighting factors of a and b in eq. (1) can be different. For example, a CU can be divided along top-left to bottom-right diagonal direction into an upper-right region and a lower-left region, as shown in FIG. 4. In FIG. 4, the weighting for the above-template-only predictor is shown in reference block 410 and the weighting for the left-template-only predictor is shown in reference block 420. Block 415 and block 425 correspond to the current block being processed. The predictor pixel in upper-right region, Predictor_UR, is equal to:

Predictor_UR=(n*left_predictor+m*above_predictor+rounding_offset)/(m+n). (2)

The predictor pixel in lower-left region, Predictor_LL, is equal to:

Predictor_LL=(m*left_predictor+n*above_predictor+rounding_offset)/(m+n). (3)

The position dependent blending may also use bilinear weighting, as shown in FIG. 5. The predictor values of four corners are shown in the FIG. 5, in which the predictor value of the bottom-left corner (denoted as Left in FIG. 5) is equal to the left mode predictor derived from the left template, the predictor value of the top-right corner (denoted as Above in FIG. 5) is equal to the above mode predictor derived from the above template, and the predictor values of the top-left corner and the bottom-right corner are the average of the left mode predictor and the above mode predictor. For a pixel inside the current CU, its predictor value I(i,j) can be derived as:

$$I ( i , j ) = \{ i \times ( H - j ) \times A + j \times ( W - i ) \times B + [ ( i \times j ) + ( W - i ) \times ( H - j ) ] \times \frac{A + B}{2} \} \times \frac{1}{W \times H} = [ ( \frac{W \times H + i \times H - j \times W}{2} ) \times A + ( \frac{W \times H - i \times H + j \times W}{2} ) \times B ] \times \frac{1}{W \times H} , \qquad ( 4 )$$

where A is the above mode predictor and the B is the left mode predictor for pixel at ((i, j) position, W is the width of the block and H is the height of the block.

Variations of DIMD:

In the original design of DIMD, the Intra mode is derived based on template matching at decoder. However, there is other side information of Intra prediction signalled in the bitstream. For example, the selection of reference lines used to generate the predictors, the selection of Intra smooth filters and the selection of Intra interpolation filters are signalled in the bitstream. Accordingly, the present invention also discloses a method based on the DIMD concept to derive the side information at decoder in order to further reduce side information in the bitstream. For example, the template matching can be used to decide which reference line should be used to generate Intra prediction with or without the signalled Intra mode in the bitstream. In another embodiment, different Intra interpolation filters are supported in Intra predictions, and the Intra interpolation filters can be evaluated by using template matching with or without the signalled Intra mode in the bitstream. In another embodiment, different Intra smooth filters can be tested by using template matching, and the best one will be used to generate the final Intra predictor with or without the signalled Intra mode in the bitstream. All of the side information can be derived based on template matching or part of them are coded in the bitstream and others are decided by using template matching and the coded information at decoder.

DIMD Parsing Issues

When DIMD is applied, the Intra prediction mode is derived based on the template matching. However, during the parsing stage at the decoder side, some syntaxes parsing and processes depend on the Intra prediction mode of the current block and one or more neighbouring blocks. For example, when decoding the significant flag of coefficient, different scan directions (e.g. vertical scan, horizontal scan or diagonal scan) can be used for different Intra modes. Different coefficient scan will use different contexts for parsing the significant flags. Therefore, before parsing the coefficients, the neighbouring pixels shall be reconstructed so that the DIMD can use the reconstructed pixels to derive the Intra mode for the current TU.

Moreover, the residual DPCM (RDPCM) needs the Intra mode of the current TU to determine whether the sign hiding should be applied or not. The DIMD Intra mode derived also affects the MPM list derivation of the neighbouring blocks and the current PU if the current PU is coded in N×N partition. The parsing and reconstruction cannot be separated into two stage when the DIMD is applied, which causes the parsing issues. In addition to the syntaxes parsing, some decoding processes also depend on the Intra mode of the current PU/TU. For example, the processing of the enhanced multiple transform (EMT), non-separable second transform (NSST), and the reference sample adaptive filter (RSAF) all depend on the Intra mode. The RSAF is yet another new coding tool considered for the next generation video coding, where the adaptive filter segments reference samples before smoothing and applies different filters to different segments.

In EMT, for each Intra prediction mode, there are two different transforms to select for the column transform and row transform. Two flags are signalled for selecting the column transform and row transform. In NSST, the DC and planar modes have three candidate transforms and other modes have four candidate transforms. The truncated unary (TU) code is used to signal the transform indices. Therefore, for DC and planar modes, up to 2 bins can be signalled. For other modes, up to 3 bins can be signalled. Accordingly, the candidate transform parsing of NSST is Intra mode dependent.

In order to overcome the parsing issues associated with DIMD, two methods are disclosed as follows.

Method-1: Always Use One Predefined Scan+Unified Parsing for Intra Mode Dependent Coding Tools.

In the reference software for the next generation video coding, some Intra mode dependent coding tools are used. For example the EMT and the NSST are two Intra mode dependent coding tools. For the EMT, two flags are required for every Intra mode. There is no parsing issue for the EMT. However, for the NSST, different Intra modes may need to parse different amounts of bins. In this method, two modifications are proposed. First, a predefined scan is used for coefficient coding. The predefined scan can be diagonal scan, vertical scan, horizontal scan, or zig-zag scan. Second, the codeword-length of NSST is unified. The same syntaxes and context formation is applied for all kinds of Intra prediction modes when decoding the NSST syntaxes. For example, all Intra modes have three NSST candidate transforms. In another example, all Intra modes have four NSST candidate transforms. For RDPCM (residual DPCM), the sign-hiding is ether always applied or always not applied for all blocks. In another example, the sign-hiding is ether always applied or always not applied for the DIMD coded block.

Furthermore, in the reference software for the next generation video coding, the Intra most probable mode (MPM) coding is used and the context selection of MPM index coding is also mode dependent. According to Method-1, it is proposed to use Intra mode independent coding for MPM index. Therefore, the context selection of MPM index only dependents on the bin index according to Method-1.

Method-2: DIMD+Normal Intra Mode.

This method solves the parsing issue by using normal Intra mode with DIMD. The predictors of the current block are the weighted sum of the normal Intra predictor and the DIMD derived Intra predictor. When the normal_intra_DIMD mode is applied, the signalled normal Intra mode is used for coefficient scan, NSST, EMT and MPM derivation.

In one embodiment of Method-2, two different DIMDs are derived. One is derived by using the above and left templates (i.e., regular DIMD). The other one can be derived from the left or above template, or the best mode from the left template and the above template as mentioned above. If the first derived mode is equal to the signalled Intra mode, the second derived mode is used. In one example, if both of the derived DIMD modes are equal to the signalled Intra mode, a predefined Intra mode is used as the DIMD mode for the current block.

Different blending method can be used for the weighted sum of the normal Intra predictor and the DIMD derived Intra predictor as shown below.

Uniform Blending:

Predictor=(a*Intra_predictor+b*DIMD_predictor+rounding_offset)/(a+b), (5)

where parameters (also referred to as weighting factors) a and b can be {1, 1} or {3,1}.

In the above equation, Predictor is the blended predictor for a given pixel in the block, Intra predictor corresponds to the normal Intra predictor for the given pixel in the block, DIMD_predictor corresponds to the DIMD derived Intra predictor for the given pixel in the block and rounding_offset is an offset value. In the above equation, the coordinates of the pixel location are omitted. Parameter a and b are constants independent of the pixel location.

Position-Dependent Blending:

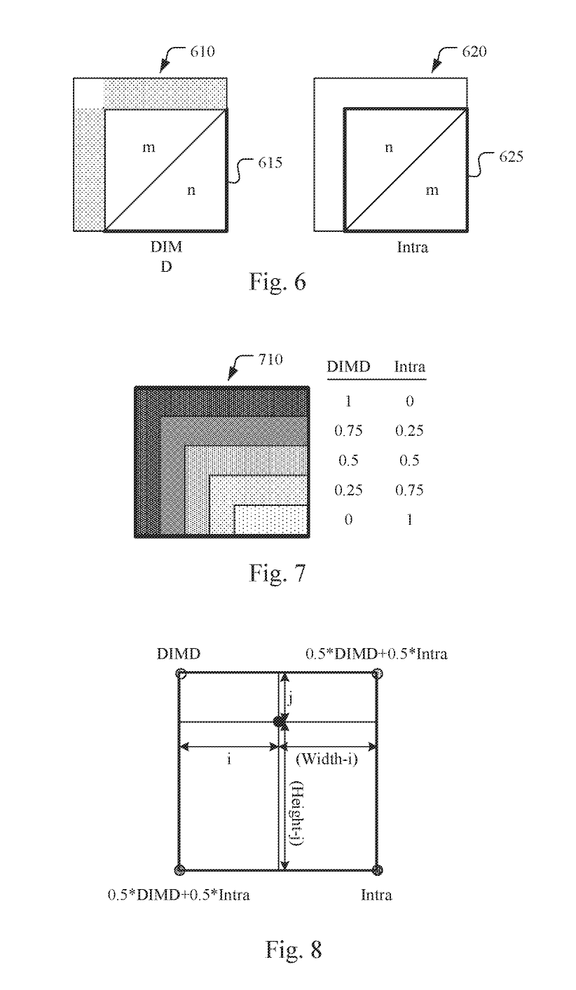

The weighting can be position dependent. For example, the current block can be partitioned into multiple regions. For different regions, the weighting factors of a and b in eq. (5) can be different. For example, a CU can be divided along bottom-left to top-right diagonal direction into an upper-left region and a lower-right region, as shown in FIG. 6. In FIG. 6, the weighting for the DIMD predictor is shown in reference block 610 and the weighting for the normal Intra predictor is shown in reference block 620. Block 615 and block 625 correspond to the current block being processed. The predictor pixel in upper-left region, Predictor_UL, is equal to:

Predictor_UL=(n*Intra_predictor+m*DIMD_predictor+rounding_offset)/(m+n). (6)

The predictor pixel in lower-right region, Predictor_LR, is equal to:

Predictor_LR=(m*Intra_predictor+n*DIMD_predictor+rounding_offset)/(m+n). (7)

Another position dependent blending can be block row/column dependent, as shown in FIG. 7. A CU is divided into multiple row/column bands. The row height or column width can be 4 or (CU_height/N)/(CU_width/M). For different row/column bands, the weighting value can be different. In FIG. 7, block 710 corresponds to a current CU and the weightings of DIMD and normal Intra predictors for various column/row bands are {1, 0.75, 0.5, 0.25, 0} and {0, 0.25, 0.5, 0.75, 1} respectively.

The position dependent blending may also use bilinear weighting, as shown in FIG. 8. The predictor values of four corners are shown in the FIG. 8. The predictor value of the top-left corner (denoted as DIMD in FIG. 8) is equal to the DIMD predictor, the predictor value of the bottom-right corner (denoted as Intra in FIG. 8) is equal to the normal Intra predictor, and the predictor values of the top-right corner and the bottom-left corner are the average of the DIMD predictor and the normal Intra predictor. For a pixel inside the current CU, its predictor value I(i,j) can be derived as:

$$I ( i , j ) = [ ( i \times j ) \times B + ( W - i ) \times ( H - j ) \times A + j \times ( W - i ) \times \frac{A + B}{2} + i \times ( H - j ) \times \frac{A + B}{2} ] \times \frac{1}{W \times H} = [ ( WH - \frac{j \times W + i \times H}{2} ) \times A + ( \frac{j \times W + i \times H}{2} ) \times B ] \times \frac{1}{W \times H} , \qquad ( 8 )$$

where A is the DIMD predictor and B is the normal Intra predictor for pixel at (i, j) position, W is the width of the block and H is the height of the block.

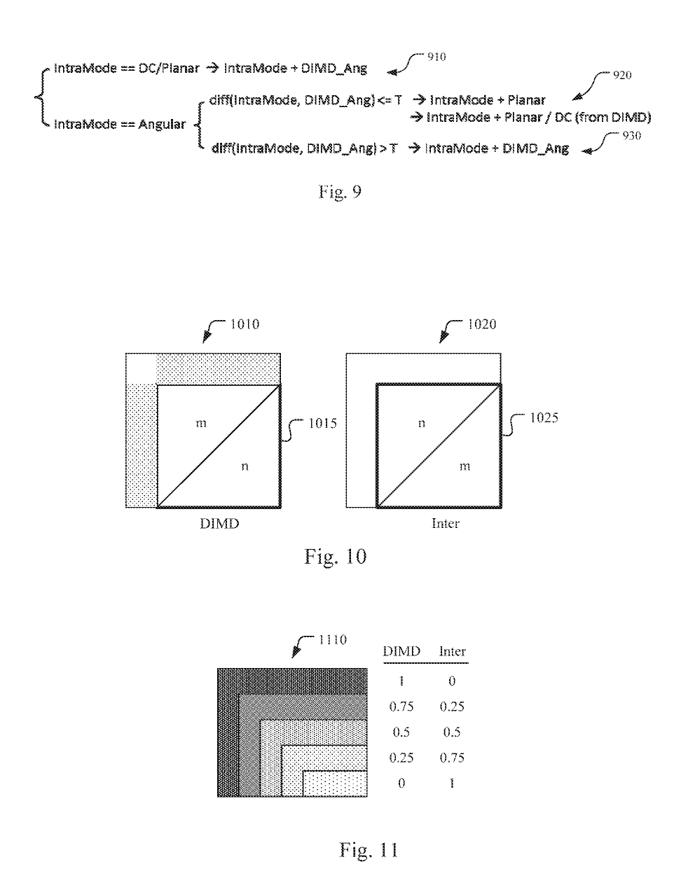

In another embodiment, the DIMD derived Intra mode can be depend on the signalled normal Intra mode. FIG. 9 shows an example of decision tree related to DIMD derived Intra mode dependent on the signalled normal Intra mode. If the signalled Intra mode is a non-angular mode (e.g., DC mode or Planar mode), a best DIMD derived angular mode is generated and used with the normal Intra mode for blending (step 910). Otherwise (i.e., intraMode==Angular), if the signalled Intra mode is the angular mode, a best DIMD mode for current block is derived. If the best DIMD mode is an angular mode, the angular difference between signalled Intra mode and the best DIMD derived mode is derived. If the angular difference is smaller than or equal to a threshold T, the planar mode or another DIMD derived best non-angular mode is used for blending (step 920). If the angular difference is larger than a threshold T, the best DIMD derived angular mode is used for blending (step 930).

In another embodiment, the DIMD derived Intra mode can be depend on the signalled normal Intra mode. First, the DIMD will derive a best mode from the angular modes (e.g. the mode 2 to mode 34 in HEVC) and a best mode from the non-angular modes (e.g. DC or planar mode). If the signalled Intra mode is the non-angular mode, the best DIMD derived angular mode is used with the normal Intra mode for blending. Otherwise (i.e., intraMode==Angular), if the signalled Intra mode is the angular mode, the angular difference between signalled Intra mode and the best DIMD derived angular mode is derived. If the angular difference is smaller than or equal to a threshold T, the planar mode or the best DIMD derived non-angular mode is used for blending. If the angular difference is larger than a threshold T, the best DIMD derived angular mode is used for blending.

Combined DIMD and Inter Mode:

In JVET-C0061, the DIMD can implicitly derive an Intra mode for Intra prediction in decoder-side to save the bit rate of signalling the intra mode. In the above disclosure, two-mode DIMD method and combined DIMD and normal Intra mode are disclosed. In the present invention, it is further proposed to combine the DIMD derived Intra mode with Inter prediction to generate a combined prediction mode.

According to this method, for each Inter CU or PU, an inter_DIMD_combine_flag is signalled. If the inter_DIMD_combine_flag is true, the left and above templates of the current CU or PU, as shown in FIG. 3, are used to generate the DIMD derived intra mode. The corresponding Intra predictors are also generated. The Intra predictor and the Inter predictor are combined to generate the new combine mode predictors.

Different blending methods can be used for the weighted sum of the Inter predictor and the DIMD derived Intra predictor as shown below.

Uniform Blending:

Predictor=(a*Inter_predictor+b*DIMD_predictor+rounding_offset)/(a+b). (9)

where parameters (also referred to as weighting factors) a and b can be {1, 1} or {3,1}. In the above equation, Predictor is the blended predictor for a given pixel in the block, Inter_predictor corresponds to the Inter predictor for the given pixel in the block, which corresponds to the Inter mode for the current CU or PU.

For uniform blending, when the DIMD mode is derived at the encoder side, the Inter motion estimation can be modified to find a better result. For example, if weighting value {a, b} is used, the final predictor is equal to (a*inter_predictor+b*DIMD_predictor)/(a+b). The residual will be calculated as (Curr−(a*inter_predictor+b*DIMD_predictor)/(a+b)), where Curr corresponds to a current pixel. In a typical encoder, a performance criterion is often used for the encoder to select a best coding among many candidates. When the combined Inter and DIMD mode is used, the derived DIMD predictor has to be used in evaluating the performance among all candidates even though the derived DIMD predictor is fixed at a given location. In order to make the combined Inter-DIMD encoding processing more computational efficient, the already derived DIMD predictor is combined with a source pixel during search for sa best Inter mode. Accordingly, the current block for Inter motion estimation can be modified as Curr′=((a+b)*Cur−b*DIMD_predictor)/a. Therefore, the residue R can be readily calculated as R=(a/(a+b))*(Curr′−inter_predictor), which can be derived from the difference between the modified input and the Inter prediction scaled by a factor, a/(a+b)). For example, if {1,1} weighting is used, the Curr′ is equal to (2*Curr−DIMD_predictor)/2. If the {3,1} weighting is used, the Curr′ is equal to (4*Curr−DIMD_predictor)/3.

Position-Dependent Blending:

The weighting can be position dependent for the combined DIMD and Inter mode. For example, the current block can be partitioned into multiple regions. For different regions, the weighting factors of a and b in eq. (9) can be different. For example, a CU can be divided along bottom-left to top-right diagonal direction into an upper-left region and a lower-right region as shown in FIG. 10. In FIG. 10, the weighting for the DIMD predictor is shown in reference block 1010 and the weighting for the Inter predictor is shown in reference block 1020. Block 1015 and block 1025 correspond to the current block being processed. The predictor pixel in upper-left region, Predictor UL, is equal to:

Predictor_UL=(n*Inter_predictor+m*DIMD_predictor+rounding_offset)/(m+n). (10)

The predictor pixel in lower-right region, Predictor_LR, is equal to:

Predictor_LR=(m*Inter_predictor+n*DIMD_predictor+rounding_offset)/(m+n). (11)

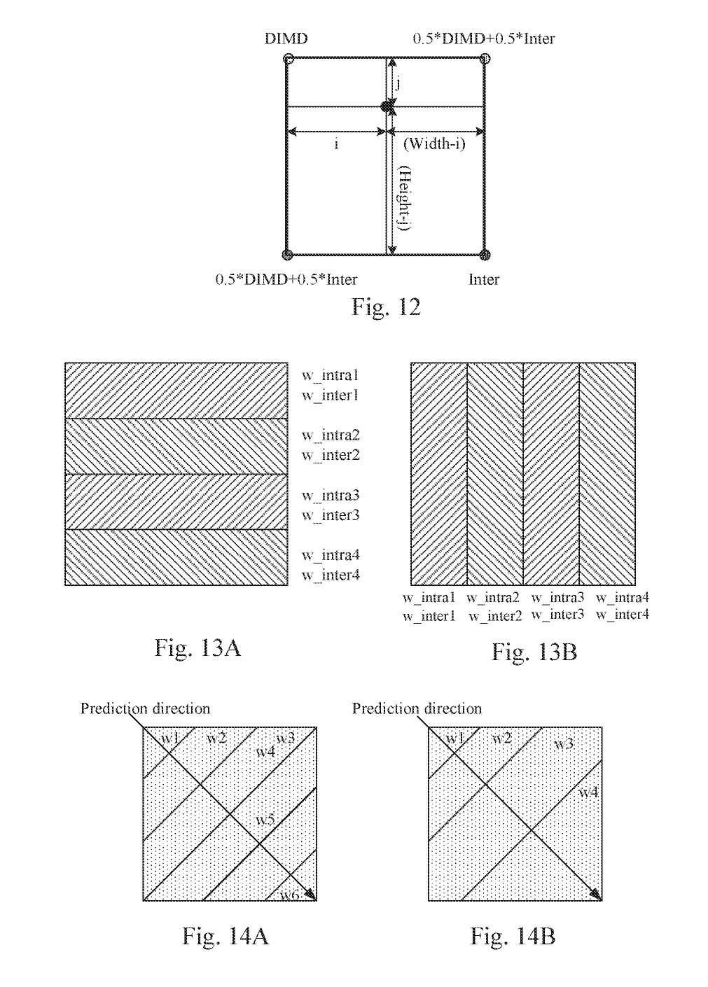

Another position dependent blending for the combined DIMD and Inter mode can be block row/column dependent, as shown in FIG. 11. A CU is divided into multiple row/column bands. The row height or column width can be 4 or (CU_height/N)/(CU_width/M). For different row/column bands, the weighting value can be different. In FIG. 11, block 1110 corresponds to a current CU and the weightings of DIMD and Inter predictors for various column/row bands are {1, 0.75, 0.5, 0.25, 0} and {0, 0.25, 0.5, 0.75, 1} respectively.

The position dependent blending for the combined DIMD and Inter mode may also use bilinear weighting, as shown in FIG. 12. The predictor values of four corners are shown in the FIG. 12. The predictor value of the top-left corner (denoted as DIMD in FIG. 12) is equal to the DIMD predictor, the predictor value of the bottom-right corner (denoted as Inter in FIG. 12) is equal to the Intra predictor, and the predictor values of the top-right corner and the bottom-left corner are the average of the DIMD predictor and the Inter predictor. For a pixel inside the current CU, its predictor value I(i, j) can be derived as:

$$I ( i , j ) = [ ( i \times j ) \times B + ( W - i ) \times ( H - j ) \times A + j \times ( W - i ) \times \frac{A + B}{2} + i \times ( H - j ) \times \frac{A + B}{2} ] \times \frac{1}{W \times H} = [ ( WH - \frac{j \times W + i \times H}{2} ) \times A + ( \frac{j \times W + i \times H}{2} ) \times B ] \times \frac{1}{W \times H} , \qquad ( 12 )$$

where A is the DIMD predictor and B is the Inter predictor at (i, j) position.

For position dependent weighting, the modified predictor method mentioned above for the DIMD Intra mode can be also applied. In the motion estimation stage, the predictor is modified with a proper weighting for finding a better candidate. In compensation stage, the position dependent weighting can be applied.

DIMD Intra Mode and Position Dependent Weighting:

In another embodiment, the weighting coefficient for the combined DIMD and Inter mode can depend on both the DIMD derived Intra mode and the position of the pixel. For example, if the DIMD derived Intra mode is non-angular Intra mode (e.g. DC or Planar), the uniform weighting coefficient can be used for all the positions. If the derived mode is an angular mode and close to the horizontal mode (i.e., DIMD Intra mode<=Diagonal Intra mode), then the weighting coefficients can be designed to change according to the horizontal distance of the pixel. If the derived mode is angular mode and close to the vertical mode (i.e., DIMD Intra mode>Diagonal Intra mode), then the weighting coefficients can be designed to change according to the vertical distance of the pixel. An example is showed in FIG. 13A and FIG. 13B. FIG. 13A is for the case that the derived mode is an angular mode and close to the vertical mode. Depending on the vertical distance of the pixel, four different weighting coefficients (i.e., w_inter1 to w_inter4 or w_intra1 to w_intra4) can be used. FIG. 13B is for the case that the derived mode is an angular mode and close to the horizontal mode. Depending on the horizontal distance of the pixel, four different weighting coefficients (i.e., w_inter1 to w_inter4 or w_intra1 to w_intra4) can be used. In another embodiment, there can be N weighting bands for horizontal direction, and M weighting bands for vertical direction. M and N can be equal or unequal. For example, M can be 4 and N can be 2. In general, M and N can be 2, 4, etc. . . . and up to the block size.

In another embodiment, the “weighting bands” can be drawn orthogonal to the angular Intra prediction direction, as illustrated in FIG. 14A and FIG. 14B. The Intra (including DIMD) and Inter weighting factors can be assigned for each band respectively, in the similar fashion as illustrated in FIG. 13A and FIG. 13B. The width of the weighting bands may be uniform (FIG. 14A) or different (FIG. 14B).

In one embodiment, the proposed combined prediction can be only applied to Merge mode. In another embodiment, it is applied to both Merge mode and Skip mode. In another embodiment, it is applied to Merge mode and AMVP mode. In another embodiment, it is applied to Merge mode, Skip mode and the AMVP mode. When it is applied to Merge mode or Skip mode, the inter_DIMD_combine_flag can be signalled before or after the merge index. When it is applied on AMVP mode, it can be signalled after merge flag or signalled after the motion information (e.g. inter_dir, mvd, mvp_index). In another embodiment, this combined prediction is applied to AMVP mode by using one explicit flag. When it is applied to Merge or Skip mode, the mode is inherited from the neighbouring CUs indicated by Merge index without additional explicit flag. The weighting for Merge mode and AMVP mode can be different.

In the combined mode, the coefficient scan, NSST, and EMT are processed as Inter coded block.

For the Intra mode of the combined prediction, it can be derived by DIMD or explicitly signalled plus DIMD refinement. For example, there are 35 Intra modes in HEVC and 67 Intra modes in the reference software called JEM (joint exploration model) for the next generation video coding. It is proposed to signal the reduced number of Intra mode (subsampled Intra modes) in the bitstream, and perform the DIMD refinement around the signalled Intra mode to find the final Intra mode for the combined prediction. The subsampled Intra modes can be 19 modes (i.e., DC+Planar+17 angular modes), 18 modes (i.e., 1 non-angular mode+17 angular mode), 11 modes (i.e., DC+Planar+9 angular modes), or 10 modes (i.e., 1 non-angular mode+9 angular mode). When the “non-angular mode” is selected, the DIMD will be used to select the best mode from the DC and Planar mode.

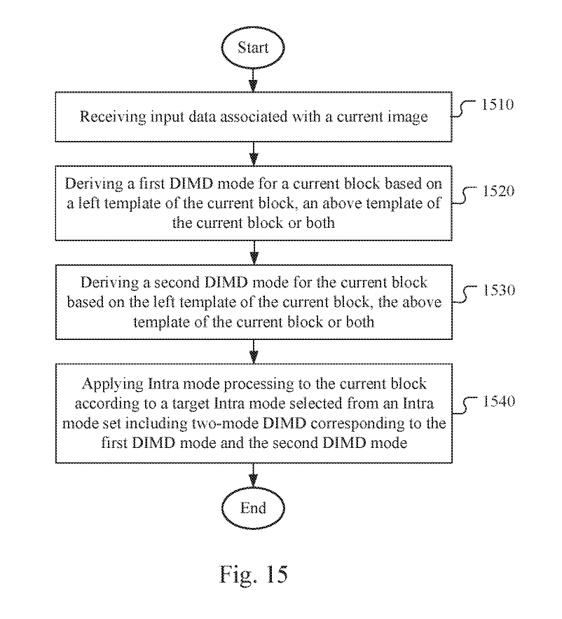

FIG. 15 illustrates a flowchart of an exemplary coding system using two-mode decoder-side Intra mode derivation (DIMD). The steps shown in the flowchart may be implemented as program codes executable on one or more processors (e.g., one or more CPUs) at the encoder side and/or the decoder side. The steps shown in the flowchart may also be implemented based hardware such as one or more electronic devices or processors arranged to perform the steps in the flowchart. According to this method, input data associated with a current image are received in step 1510. A first DIMD mode for a current block is derived based on a left template of the current block, an above template of the current block or both in step 1520. A second DIMD mode for the current block is derived based on the left template of the current block, the above template of the current block or both in step 1530. Intra mode processing is then applied to the current block according to a target Intra mode selected from an Intra mode set including two-mode DIMD corresponding to the first DIMD mode and the second DIMD mode in step 1540.

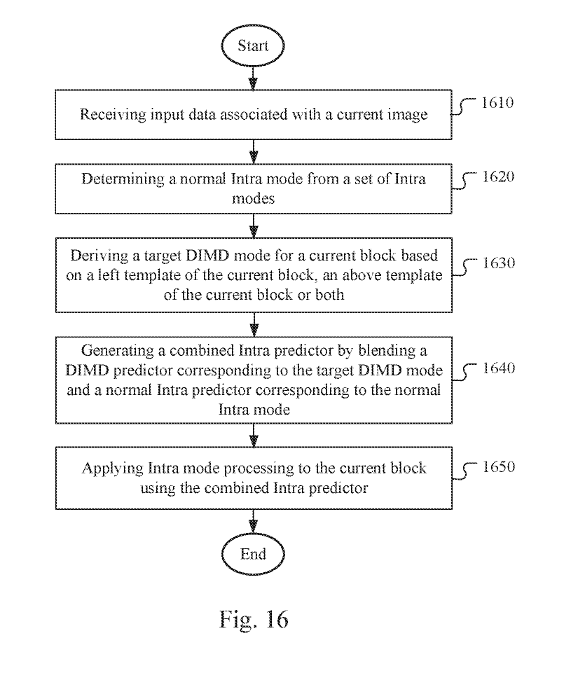

FIG. 16 illustrates a flowchart of an exemplary coding system using a combined decoder-side Intra mode derivation (DIMD) mode and a normal Intra mode. According to this method, input data associated with a current image are received in step 1610. A normal Intra mode from a set of Intra modes is derived in step 1620. A target DIMD mode for the current block is derived based on the left template of the current block, the above template of the current block or both in step 1630. A combined Intra predictor is generated by blending a DIMD predictor corresponding to the target DIMD mode and a normal Intra predictor corresponding to the normal Intra mode in step 1640. Intra mode processing is then applied to the current block using the combined Intra predictor in step 1650.

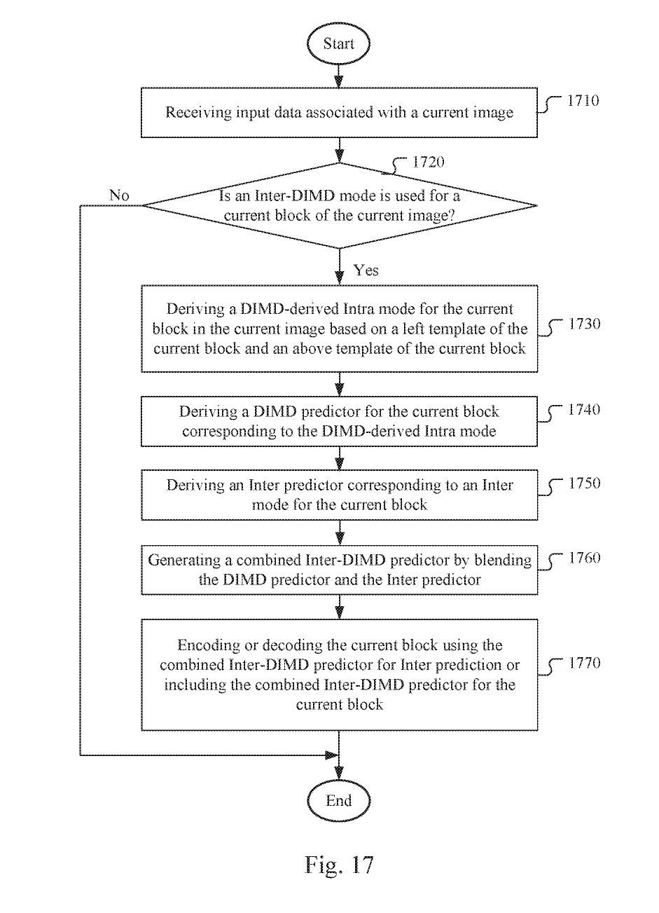

FIG. 17 illustrates a flowchart of an exemplary coding system using a combined decoder-side Intra mode derivation (DIMD) mode and a normal Intra mode. According to this method, input data associated with a current image are received in step 1710. Whether an Inter-DIMD mode is used for a current block of the current image is checked in step 1720. If the result is “Yes”, steps 1730 through 1770 are performed. If the result is “No”, steps 1730 through 1770 are skipped. In step 1730, a DIMD-derived Intra mode for the current block in the current image is derived based on a left template of the current block and an above template of the current block. In step 1740, a DIMD predictor for the current block corresponding to the DIMD-derived Intra mode is derived. In step 1950, an Inter predictor corresponding to an Inter mode for the current block is derived. In step 1760, a combined Inter-DIMD predictor is generated by blending the DIMD predictor and the Inter predictor. In step 1770, the current block is encoded or decoded using the combined Inter-DIMD predictor for Inter prediction or including the combined Inter-DIMD predictor in a candidate list for the current block.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1-19. (canceled)

20. A method of video coding using decoder-side Intra mode derivation (DIMD), the method comprising:
receiving input data associated with a current image;
if an Inter-DIMD mode is used for a current block of the current image:
deriving a DIMD-derived Intra mode for the current block in the current image based on a left template of the current block and an above template of the current block;
deriving a DIMD predictor for the current block corresponding to the DIMD-derived Intra mode;
deriving an Inter predictor corresponding to an Inter mode for the current block;
generating a combined Inter-DIMD predictor by blending the DIMD predictor and the Inter predictor; and
encoding or decoding the current block using the combined Inter-DIMD predictor for Inter prediction or including the combined Inter-DIMD predictor in a candidate list for the current block.

21. The method of claim 20, wherein the combined Inter-DIMD predictor is generated using uniform blending or position-dependent blending by combining the DIMD predictor and the Inter predictor, and wherein weighting factors for the uniform blending are uniform for an entire current block.

22. The method of claim 21, wherein when the combined Inter-DIMD predictor is used for Inter prediction of the current block, a current pixel is modified into a modified current pixel to include a part of the combined Inter-DIMD predictor corresponding to the DIMD predictor so that a residual between the current pixel and the combined Inter-DIMD predictor is calculated from a difference between the modified current pixel and the Inter predictor.

23. The method of claim 22, wherein the current block is divided along bottom-left to top-right diagonal direction into an upper-left region and a lower-right region; a first predictor for pixels in the upper-left region is determined according to (n*DIMD predictor+m*Inter predictor+rounding_offset)/(m+n); a second predictor for pixels in the lower-right region is determined according to (m*DIMD predictor+n*Inter predictor+rounding_offset)/(m+n); and wherein rounding_offset is an offset value for a rounding operation and m and n are two weighting factors.

24. The method of claim 22, wherein the current block is divided into multiple row/column bands and the combined Inter-DIMD predictor is generated by combining the DIMD predictor and the Inter predictor according to a weighted sum, and wherein weighting factors are dependent on a target row/column band where a pixel is located.

25. The method of claim 22, wherein the combined Inter-DIMD predictor is generated using bilinear weighting based on four corner values of the current block with the DIMD predictor at a top-left corner, the Inter predictor at a bottom-right corner, an average of the DIMD predictor and the Inter predictor at a top-right corner and a bottom-left corner.

26. The method of claim 22, wherein the weighting factors are further dependent on the DIMD-derived Intra mode.

27. The method of claim 26, wherein if the DIMD-derived Intra mode is an angular mode and close to horizontal Intra mode, the weighting factors are further dependent on horizontal distance of a current pixel with respect to a vertical edge of the current block; or if the DIMD-derived Intra mode is the angular mode and close to vertical Intra, the weighting factors are further dependent on vertical distance of the current pixel with respect to a horizontal edge of the current block.

28. The method of claim 26, wherein the current block is partitioned into multiple bands in a target direction orthogonal to a direction of the DIMD-derived Intra mode and the weighting factors are further dependent on a target band that a current pixel is located.

29. The method of claim 20, wherein whether the Inter-DIMD mode is used for the current block of the current image is indicated by a flag in a bitstream.

30. The method of claim 20, wherein the combined Inter-DIMD predictor is generated using blending by linearly combining the DIMD predictor and the Inter predictor according to weighting factors, and wherein the weighting factors are different for the current block coded in a Merge mode and an Advanced Motion Vector Prediction (AMVP) mode.

31. An apparatus of video coding using decoder-side Intra mode derivation (DIMD), the apparatus comprising one or more electronic circuits or processors arrange to:
receive input data associated with a current image;
if an Inter-DIMD mode is used for a current block of the current image:
derive a DIMD-derived Intra mode for a current block in the current image based on a left template of the current block and an above template of the current block;
derive a DIMD predictor for the current block corresponding to the DIMD-derived Intra mode;
derive an Inter predictor corresponding to an Inter mode for the current block;
generate a combined Inter-DIMD predictor by blending the DIMD predictor and the Inter predictor; and
encode or decode the current block using the combined Inter-DIMD predictor for Inter prediction or including the combined Inter-DIMD predictor in a candidate list for the current block.
